(19) United States
(12) Patent Application Publication
(10) Pub. No.: US 2024/0249296 A1
(43) Pub. Date: Jul. 25, 2024

(54) Efficient Feature Engineering for Recommender Systems

(71) Applicant: The Boston Consulting Group, Inc., Boston, MA (US)

(72) Inventors: Davide Guatta, Brescia (IT); Alex Bergamasco, Palmanova UD (IT)

(21) Appl. No.: 18/158,597

(22) Filed: Jan. 24, 2023

(51) Int. Cl. G06Q 30/0201

(52) U.S. Cl. CPC G06Q 30/0201

(57) ABSTRACT

Described is a recommender engine where a first plurality of customers prospects is exposed to a second plurality of potential actions, the recommender engine filters tuples of customers and actions according to one or more applied business rules, generates features that identify a primary key that characterizes a specific feature to determine a minimum level of representation to eliminate redundancy, the feature generator executes a feature calculation to fit feature values per each primary key that are computed to subsequently reconstruct the feature per each primary key, transforms the features to return the feature values according to a number of primary keys that needs to be fetched, composes a feature matrix that includes a portion of the primary keys that needs to be fetched, scores the portion of the primary keys from feature matrix, and issues recommendations for tuples of customers and actions according to the feature matrix.

### BACKGROUND

This invention relates to feature engineering for recommendation systems.

A recommender system is where a number of customer prospects are exposed to a number of potential actions. The customer prospects and actions are optionally filtered by applying business rules. Features representing such interactions are generated by a feature engineering system and every interaction is scored by an array of models. The output scores are used to generate a recommendation, by selecting a subset of the actions per each customer prospect according to the scores and business rules.

In a classical setup of a feature engineering system, features are computed according to primary keys of an input data structure to produce a feature matrix. The feature matrix is produced during a feature generation process. The feature matrix is usually generated in full, without exploitation of redundancies (e.g., a customer feature is repeated when two offers are ranked against the same customer). The collaborative features and/or features arising from applying a matrix factorization to the feature matrix are computed in full to reconstruct the feature matrix with a pre-specified level of regularization. A customer interaction matrix is represented as a product of two smaller “component matrices” with dimensionalities equal to a number of customers “N” minus a number of embeddings “M” (N-M), and a number of embeddings “M” minus a number of items “P” (M-P).

The customer interaction matrix is then reconstructed via a matrix multiplication, where the number of embeddings M to consider is a degree of freedom. With more embeddings M, the reconstruction is more accurate, while with less embeddings M, the reconstruction becomes more highly regularized. Users, however, need to choose upfront which level of regularization to use and use considerable memory resources to memorize the reconstructed matrix.

### SUMMARY

In the present solution, the feature generation process is separated from the feature matrix generation process. The former results in a data structure where only the unique primary keys are stored (thus removing any duplicated and redundant keys), while a matrix production process (i.e., a “feature transform”) process occurs at a second, subsequent stage.

The feature transform (and subsequent ranking) can be generated on demand, allowing for parallelization of a scoring process (e.g., generate a feature matrix for the first ten customers, rank the first ten customers, then generate the feature matrix for the next ten customers, and so on). Parallelization can occur in both parallel (e.g., multi-core CPUs and GPUs) and distributed (e.g., cluster computing) fashion. Redundancy is maximally exploited as all the features are computed only once and fetched on-demand, that is, no double computations but only a memory copy of a single value.

Factorized features are represented through stored “component matrices” that have a small memory footprint (occupy relatively small amount of memory in comparison to the prior art) compared to storing in an explicit way all the possible customer-action interactions. Only, at the moment that the entire feature matrix has to be built, specific elements of the reconstructed matrix will be retrieved via a specialized partial matrix multiplication. Moreover, given that the reconstruction through multiplication is performed “on the fly”, it's possible to efficiently obtain several levels of reconstruction thus giving more flexibility and expressive power to this type of feature.

This invention solves the problem of efficiently computing the feature engineering step in recommender systems, by exploiting parallelism and redundancy, and splitting the computational steps of feature calculation and feature matrix generation that, usually, coincide. Moreover, the proposed solution allows to efficiently obtain reconstruction from embeddings (which are common features in the recommender system domain, like the output of collaborative filtering, implementing different level of regularizations at once.

According to an aspect, a computer system includes a recommender engine where a first plurality of customers prospects is exposed to a second plurality of potential actions, the recommender engine including executable computer instructions that configure the computer system to filter tuples of customers and actions according to one or more applied business rules, generate features that identify a primary key that characterizes a specific feature to determine a minimum level of representation to eliminate redundancy, the feature generator executes a feature calculation to fit feature values per each primary key that are computed to subsequently reconstruct the feature per each primary key, transform the features to return the feature values according to a number of primary keys that needs to be fetched, compose, a feature matrix that includes a portion of the primary keys that needs to be fetched, score the portion of the primary keys from feature matrix, and issue recommendations for tuples of customers and actions according to the feature matrix.

Other aspects include computer program products and computer implemented methods.

One or more of the above aspects may include amongst features described herein one or more of the following features.

The recommender engine further includes instructions to generate component matrices that represent factorized features.

A matrix multiplication is applied to the factorized features represented through component matrices to provide a reconstructed matrix.

The feature generation process is separated from the feature matrix generation process.

The feature generation process provides a data structure where only unique primary keys and corresponding features values that are indexed by the primary keys are stored.

The feature matrix is composed on demand.

The feature matrix composed on demand includes a feature class including a customer-level stored according to values of recency, frequency and, monetary, an action-level stored according to values of discount and channel, and a customer/action level stored according to a share of basket value and a propensity value.

Unique keys are processed in individual threads of execution by the computer system.

One or more of the above aspects or other aspects as described herein may include one or more of the following advantages.

Space complexity is reduced, as only the minimum necessary information is stored in memory, thus reducing the requirements and operational costs of running such a solution. Redundancy is maximally exploited. For instance, a customer feature that will be participating in more than one prediction scoring, will be stored only once. Finally, this solution is extremely relevant for customer-action features (i.e., all the features that can potentially assume a unique value per each customer-action couple). If such features are stemming from a factorization process (e.g. collaborative filtering), only the component matrix is retained instead of storing the full matrix. Whereas, in case of sparse features, where most elements are equal to zero or another escape value (e.g., level of spending of a customer on a specific item, where only a handful of items are purchased by each customer), only non-zero elements can be stored.

Time complexity the parallel construct and implemented transform architecture in the solution allows to parallelize the prediction and scoring process, thus taking advantage of parallel (e.g., multi-core, GPU) architectures as well as distributed architectures by reducing computational speed multiple times and fully using the available processing resources, thus reducing operational costs.

The feature organization requested by the solution (i.e., explicit declaration of the primary keys used to index the feature themselves), and the underlying data structures that arise from such an architecture make the approach suited to be used as a feature store, potentially also allowing for addition/removal of keys, storage of multiple snapshots over time etc.).

Factorization reconstruction at different levels of regularization is possible. In the case of factorizations, where a single prediction is bound to a matrix multiplication between customer and product features reduced to a number of embeddings, is it possible to develop a multiplication for different numbers of embeddings (from one to all the available ones). The multiple reconstructions constitute a “multi-resolution” representation of the interaction feature between a customer and product, characterized by different levels of regularizations. The different levels of regularizations result in an improved prediction performances or direct support to uplift models, where a more regularized prediction is more correlated with the un-incentivized behavior of the customer while the less regularized one more reflecting the other customers' behavior.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a data processing system.

FIG. 2 is a flow diagram of a recommendation process.

FIG. 3 is a diagram depicting a standard, i.e., conventional recommendation pipeline. (Prior Art)

FIG. 4 is a diagram depicting redundancies exploited in the recommendation process.

FIG. 5 is a diagram depicting parallelization of the structure of FIG. 4.

FIG. 6 is a diagram depicting features precomputed by class.

FIG. 7 is a diagram depicting a distributed computing environment implementation.

FIG. 8 is a diagram depicting a computer system.

### DETAILED DESCRIPTION

An embedding is defined as a relatively low-dimensional space into which high-dimensional vectors can be translated. Embeddings make it easier to do machine learning on large inputs like sparse vectors representing words. An embedding provides semantics of an input by placing semantically similar inputs close together in an embedding space. An embedding can be learned and reused.

Factorization is defined as a process that involves writing a mathematical object as a product of several factors, usually smaller or simpler objects of the same kind.

A feature is defined as a prominent part or characteristic.

Memory footprint is defined as an amount of memory space used.

A primary key is defined as a specific choice of a minimal set of attributes that uniquely specify a tuple in a relation.

A regularization is defined as a process that changes a result answer to be “simpler.”

A tuple is defined as a finite ordered list of elements.

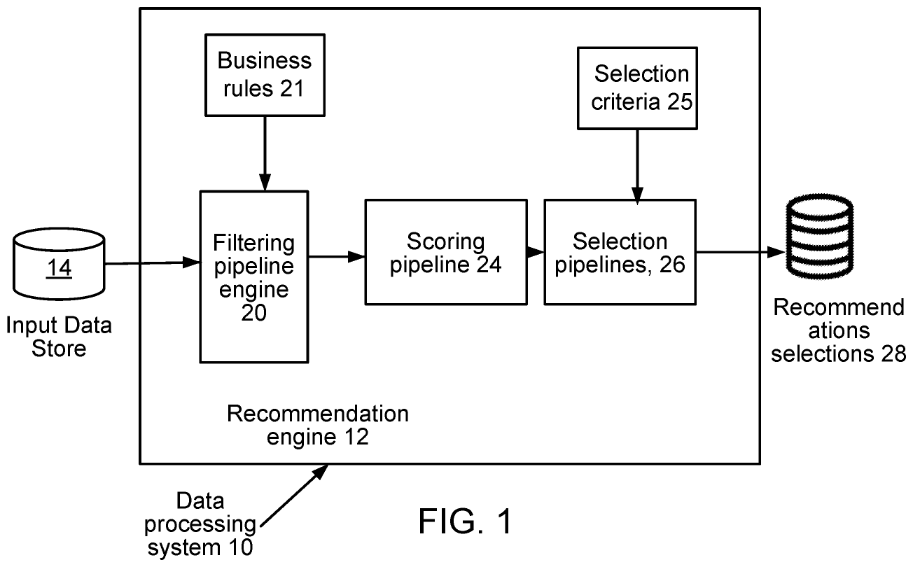

Referring now to FIG. 1, a data processing system 10 is shown. The data processing system 10 includes a recommendation engine 12 and an input data store 14. The input data store 14 is a non-transitory hardware storage device that is either persistent, i.e., data remains when power is removed, or non-persistent, i.e., data is lost when power is removed. The input data store 14 has data that stores records including “customer prospects” records and potential action records in a database. Actions are typically marketing actions that generate increase engagement, brand awareness, incremental click rate, incremental sales, incremental margins. Marketing actions can be of several type such as communication actions, discount offers and a combination of both. Action records are database records that store types of actions. The recommendation engine 12 processes the input data to provide customer prospects and primary keys of each feature.

The recommendation engine 12 receives “customer prospects” records and potential action records from the input data store 14. The recommendation engine 12 also includes a filtering pipeline engine 20 that executes business rules 21 to filter out received “customer prospects” records and potential action records (tuples) from scoring, according to whether or not the tuples pass the business rules. The recommendation engine 12 also includes scoring pipelines 24 that score the filtered tuples. The filtered tuples from the scoring pipelines 24 are input to selection pipelines 26. The selection pipelines 26 select tuples, according to selection criteria 27 and output recommendation selections 28.

The recommendation engine 12 provides an optimized data structure, a feature matrix, that is optimized according to space complexity, time complexity, feature organization and factorization reconstruction.

Optimized, according to space complexity, means that the feature matrix stores only the minimum necessary information in the memory, thus reducing memory requirements and operational costs of running the recommendation engine 12. Redundancy is maximally exploited. For example, a customer prospect feature that will be participating in more than one prediction scoring will be stored only once. For factorization-related features, a single factorization component is stored vs a full matrix as in the prior art approaches.

Optimized, according to time complexity, has a parallel construct that implements a “transform” architecture in the solution to parallelize prediction and scoring process, thus taking advantage of parallel (e.g., multi-core, GPU) architectures as well as distributed architectures by reducing computational speed multiple times and fully using the available processing resources, thus reducing operational costs.

Optimized, according to feature organization, has the feature organization requested by the solution (i.e., explicit declaration of the primary keys used to index the feature themselves) and the underlying data structure that arises from such an architecture make the approach suited to be used as a feature store, potentially also allowing for addition/removal of keys, storage of multiple snapshots over time etc.

Optimized, according to factorization reconstruction, as it allows to efficiently compute at different levels of regularization. In the case of factorizations, where the single prediction is bound to a matrix multiplication between customer and product features reduced to a number of embeddings, is it possible to develop the multiplication for different number of embeddings (from one to all the available ones). The multiple reconstructions constitute a “multi-resolution” representation of the interaction feature between a customer prospect and product, characterized by different levels of regularizations. The “multi-resolution” representation results in an improved prediction performances or direct support to uplift models, where a more regularized prediction is more correlated with the incentivized behavior of the customer prospect while the less regularized one more reflecting the other customer prospect's behavior.

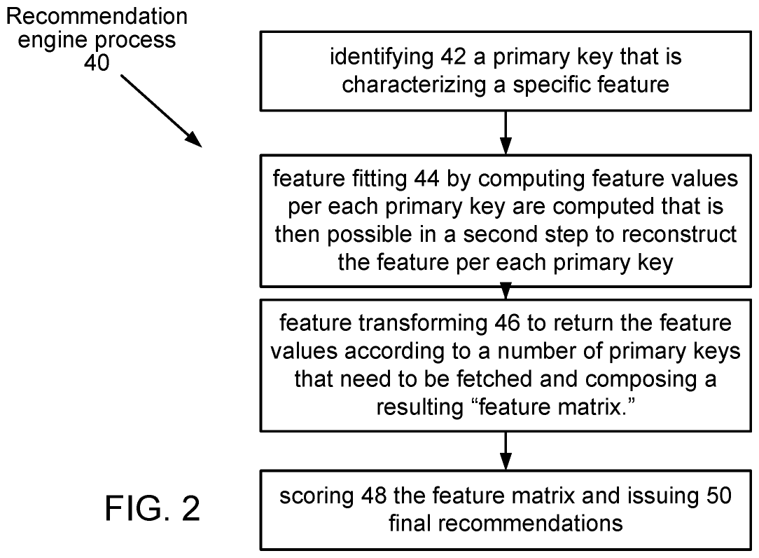

Referring now to FIG. 2, a recommendation engine process 40 includes identifying 42 a primary key that is characterizing a specific feature to determine what is the minimum level of representation that is allowed to eliminate any redundancy, that is to ensure that only unique keys are computed and stored and all duplicated keys are dropped, thus optimizing both time and space complexity. For instance, if the feature to compute is a customer-level feature, like monetary value, the primary key will be a unique customer identifier. Identifying 42 the primary key involves declaring or designing primary keys to index a unique set of features' basic components, per feature. The feature components are data that fully reconstruct the feature per each primary key that is stored. The primary keys are in a 1:1 associated with unique values that the features can take. For instance, a customer feature primary key will be typically a unique customer identifier, and will allow reconstruction of features for all customers and will assume a value, potentially unique and different with respect all the other customers, linked to the customers for which this feature is computed. At the same time, should the recommendation engine process 40 compute the feature when characterizing a customer-item interaction, regardless of the item proposed, the customer feature will remain the same. That is, the primary key allows to define the feature class, that is, the set of primary keys of each feature. For instance two features sharing the unique customer ID as the primary key can be classified as a ‘customer-level’ feature class.

The recommendation engine process 40 further includes feature fitting 44, where all features per each primary key are computed in such a way that is then possible in a second step to reconstruct the feature per each primary key. Feature fitting 44 stores all the data necessary to compute the feature, organizing the features by primary keys. In the case of relatively simple features, this corresponds to one or more elements in the case of vectorial features, characterized by more than one value corresponding to a primary key (e.g. assume to define a ‘customer-class’ feature named ‘customer consumption’, that reports recency, frequency and monetary value statistics, for a specific customer in a defined time window). Such features are typically represented in a columnar format where the primary keys are represented instead as rows. In the case of embeddings/factorizations, store the underlying component matrices that are needed to reconstruct the original matrix without performing any reconstruction.

The recommendation engine process 40 further includes feature transforming 46 to return the feature values according to a number of primary keys that need to be fetched and composing a resulting “feature matrix.” This process is carried over by iterating on all the defined features, providing all of them with the relevant primary keys (e.g. customer ID, action ID) and fetching the features' values corresponding to these keys (or reconstructing only these elements in the case of factorization features). This process is referred to as ‘feature transforming.’ Optionally, the feature transforming 46 can be performed in a parallelized way, by splitting the total primary keys that are requested into smaller non overlapping sets that are then processed in parallel.

The recommendation engine process 40 further includes scoring 48 the feature matrix and issuing 50 final recommendations. When the scoring pipeline is executed, the recommendation engine process 40 builds the feature matrix on the fly, via feature transforming 46.

During scoring 48, the primary keys tuples that are required (e.g. Cust 1-Action 1, Cust 1-Action 2, Cust 2-Action 3, etc. will be known.) These tuples are used to index the primary keys for the simple features, potentially ignoring some of the keys. For example, in the case of customer features, all primary keys, except the customer ID key will be ignored. The primary keys will be used to index the stored feature returning the associated feature values (columns). In case of factorization matrices, the primary keys will be used in a similar process but typically the stored “component matrices” will be indexed each one with a different primary key. In the case of factorization matrices, after the fetching process a matrix product will occur to obtain the final reconstructed matrixes.

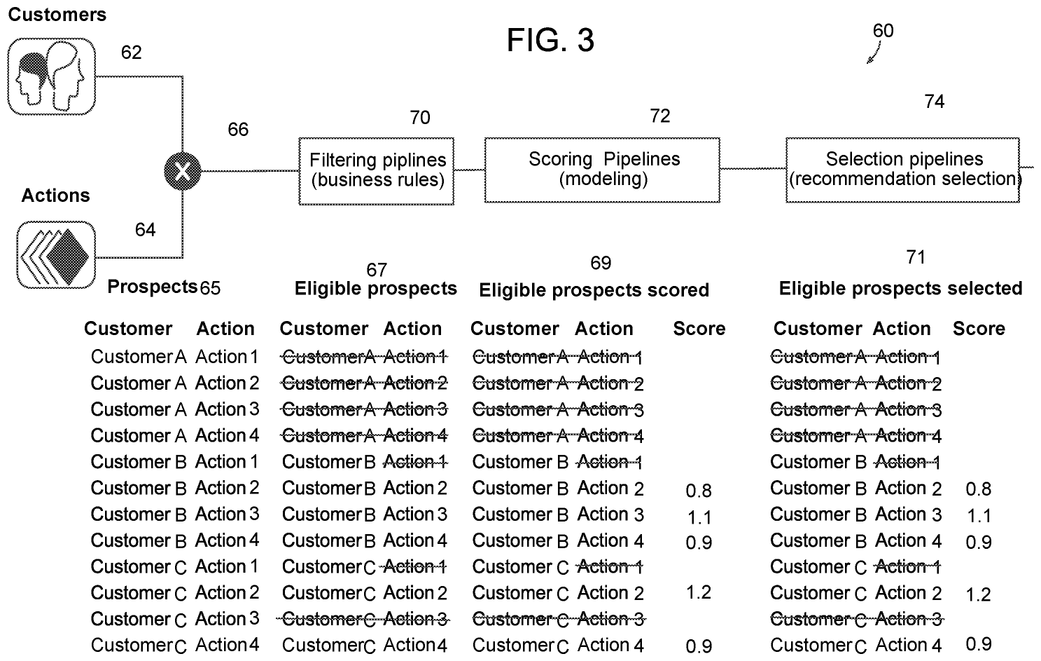

Referring now to FIG. 3, a standard recommendation pipeline 60 receives customer ID's 62, and actions 64 from input data store 14 and forms products 65 of the customer ID's and actions. These products 65 of customer ID′. and actions provide prospects 65 that are fed to the standard recommendation pipeline 60.

The standard recommendation pipeline 60 includes three main pipeline stages, after recommendation scope generation. These are filtering pipelines 70, scoring pipelines 72, and selection pipelines 74.

The standard recommendation pipeline 60 applies the products 65 of customer ID's and actions to the filtering pipelines 70. The filtering pipelines applies business rules to the products 65 of customer ID's and actions and produces a listing of eligible prospects 67. The listing of eligible prospects 67 are scored by the scoring pipelines 72 producing a listing of scored, eligible prospects 69. The selection pipelines 74 provides a listing of selected, eligible prospects 71. Criteria are used for selecting the eligible prospects, e.g., all the selected, eligible prospects 71 can be selected, or selected, eligible prospects 71 having a score greater than 1.0, can be selected, etc.

As shown in FIG. 3, customer A-Action 1 through customer A-Action 4 were not eligible by virtue of those combinations not meeting one or more business rules.

customer A-Action 1 through customer A-Action 4 therefore are not eligible for scoring or selection.

customer B-Action 1 is not eligible, but customer B-Action 2 through customer B-Action 4 are eligible as are customer C-Action 2 and customer C-Action 4.

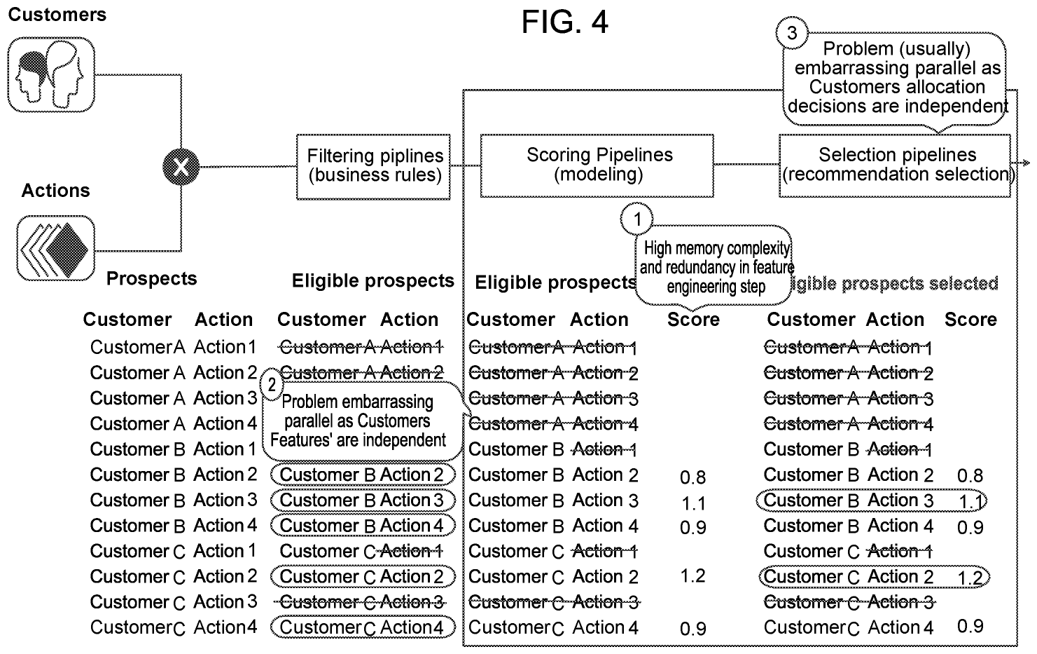

FIG. 4 shows several observations pertaining to FIG. 3. One is the observation that the customer features are independent, meaning that the calculation and transformation of features relative to a specific customer, are independent from the calculation of features of any other customer. The fact that these calculations are independent make possible to parallelize or distribute the overall calculation process. In this way, the scoring pipelines exploit redundancy, as instead of computing all the customers at once a predefined number of them can be processed at the same time (storing the results of the scoring process) to then process a subsequent batch (compared to computing the features of all the customers at once, scoring all the customers at once and then store this information).

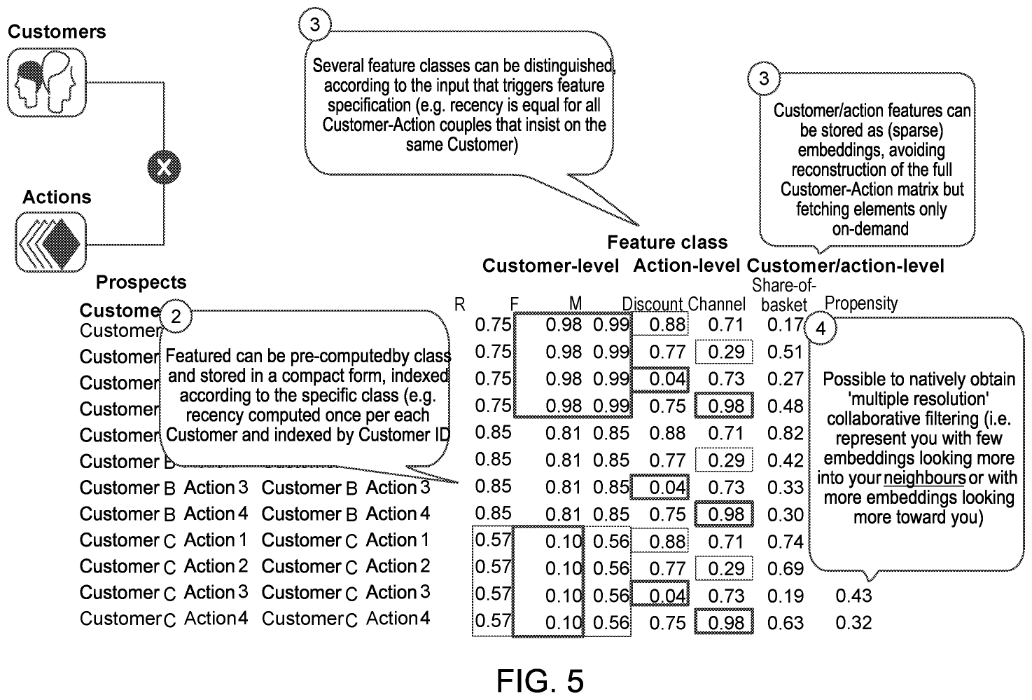

Referring now to FIG. 5, a modified recommendation pipeline 80 that includes a feature generator 84 is shown. The modified recommendation pipeline 80 receives the customer ID's 62, and actions 64 from input data store 14 and forms the products 65 of the customer ID's and actions to provide prospects 65. These products of customer ID's and actions, prospects 65, are features that are precomputed by class and stored in a compact form and indexed according to class. For example, recency is computed once per customer and indexed according to customer ID. Several feature classes are distinguished according to input that triggered feature specification, e.g., recency is equal for all customer-action couples that insist on the same customer. Customer-action features are stored as sparse embeddings, avoiding reconstruction of the full customer-action matrix, but fetching elements only on demand. It is thus possible to natively obtain “multiple resolutions” collaborative filtering, (i.e., represent a customer with a few embeddings.

The following is an approach. The process computes an ‘economy’ representation of all features, to effectively ‘pre-train’ the features). The customer-level features (e.g. RFM features, Recency, Frequency, Monetary valve) are computed and stored only once per customer without repetitions. The customer-item features (e.g. level of expenditure for a customer on an item) are represented, for example, in a sparse format. A singular value decomposition (SVD) is calculated, (e.g., SVD: X=U*s*V), were X is a singular value decomposition, and U, s and V are embeddings. The SVD calculation stores the embeddings (e.g., U, s, V) that can be used to compute the features instead of the full reconstructed value (X′=UsV). One of the benefits of this step is that there is a significantly reduced memory footprint.

Customers are processed in batches and the feature matrix is generated by fetching the right values from the previously stored features, i.e., if a customer is scored against three offers, the customer-level features (e.g. RFM) will be fetched once and replicated three times without need to re-compute the customer-level features three times. For collaborative features that are represented through the embeddings, only required tuples are obtained (typically through matrix multiplication, no full matrix multiplication will occur, only few elements).

The process computes scores by applying the model to the feature matrix, potentially in a parallelized way. Benefit of this step is that there is no recalculation of features, only inexpensive memory accesses/memory copy or minimum required matrix multiplications. Moreover, the memory footprint is entirely under control and can be tuned for a specific virtual machine (VM) used.

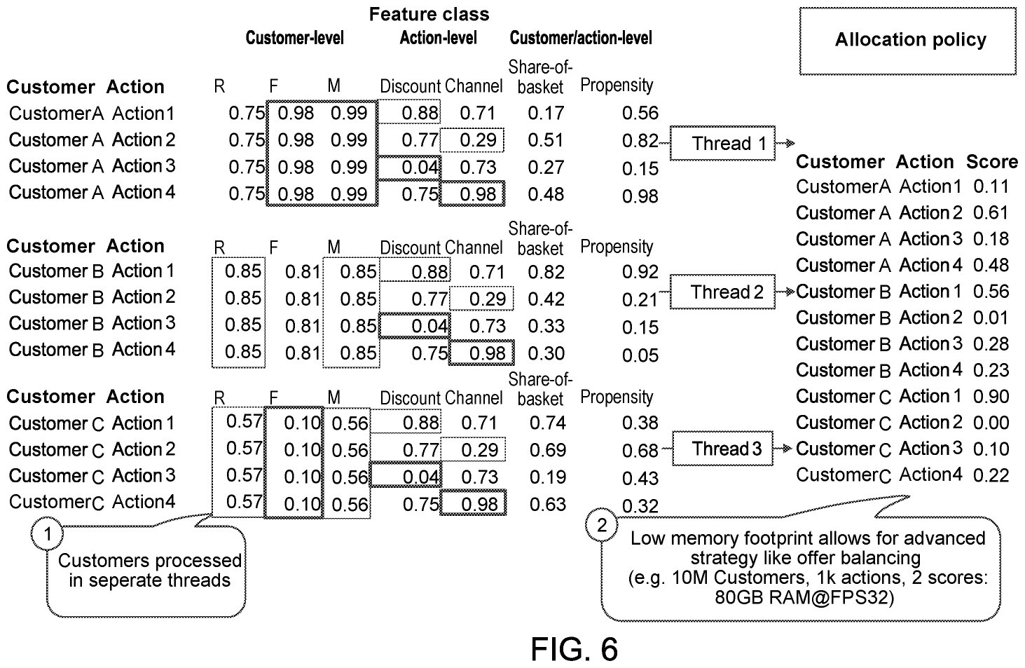

Referring now to FIG. 6, during scoring, the feature matrix (i.e., data structure) is used to allow for parallelization and a low memory footprint (e.g., lower amount of memory in comparison to the recommendation engine process 40 of FIG. 3). The modified recommendation pipeline 80 shows customers processed in separate threads, e.g., customer A-Action 1 through customer A-Action 4 were processed in thread 1; customer B-Action 1 through customer B-Action 4 and customer C-Action 1 through customer C-Action 2 were processed in thread 2; and customer C-Action 3 through customer C-Action 4 were processed in thread 3. This provides the low memory footprint (lower amount of memory in comparison to the recommendation engine process 40 of FIG. 3).

### Example Distributed Computing System Environment

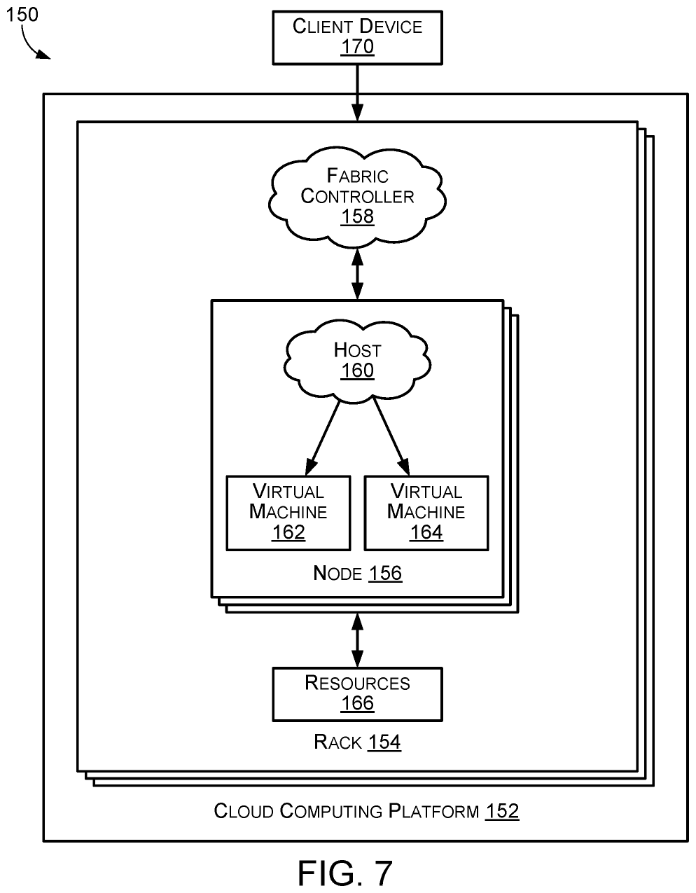

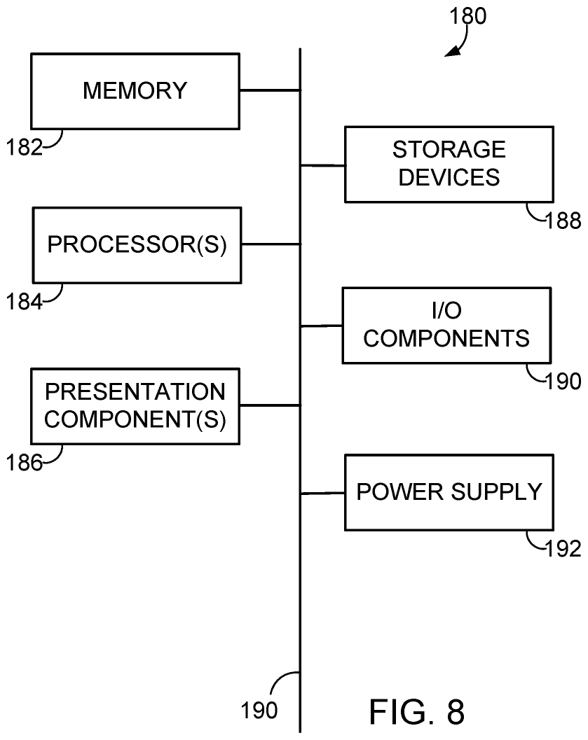

Referring now to FIG. 7, an example of a distributed computing environment 150 is shown. FIG. 8 shows a high-level architecture of a cloud computing platform 152 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

The distributed computing environment 150 includes data centers that includes cloud computing platform 152, rack 154, and node 156 (e.g., computing devices, processing units, or blades) in rack 154. The technical solution environment can be implemented with cloud computing platform 152 that runs cloud services across different data centers and geographic regions. Cloud computing platform 152 can implement fabric controller 158 component for provisioning and managing resource allocation, deployment, upgrade, and management of cloud services. Typically, a cloud computing platform 152 acts to store data or data analytics applications in a distributed manner. Cloud computing platform 152 in a data center can be configured to host and support operation of endpoints of a particular service application. Cloud computing platform 152 may be a public cloud, a private cloud, or a dedicated cloud.

Node 156 can be provisioned with host 160 (e.g., operating system or runtime environment) execution a defined software stack on node 156. Node 156 can also be configured to perform specialized functionality (e.g., compute nodes or storage nodes) within cloud computing platform 152. Node 156 is allocated to run one or more portions of a service application of a tenant. A tenant can refer to a customer utilizing resources of cloud computing platform 152. Service application components of cloud computing platform 152 that support a particular tenant can be referred to as a tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 156, nodes 156 may be partitioned into virtual machines (e.g., virtual machine 162 and virtual machine 164). Physical machines can also concurrently run separate service applications. The virtual machines or physical machines can be configured as individualized computing environments that are supported by resources 166 (e.g., hardware resources and software resources) in cloud computing platform 152. It is contemplated that resources can be configured for specific service applications. Further, each service application may be divided into functional portions such that each functional portion is able to run on a separate virtual machine. In cloud computing platform 152, multiple servers may be used to run data analytics applications and perform data storage operations in a cluster. In particular, the servers may perform data operations independently but exposed as a single device referred to as a cluster. Each server in the cluster can be implemented as a node.

Client device 170 may be linked to a service application in cloud computing platform 152. Client device 170 may be any type of computing device, which may correspond to computing device 180 described with reference to FIG. 8. For example, client device 170 can be configured to issue commands to cloud computing platform 152. In embodiments, client device 170 may communicate with data analytics applications through a virtual Internet Protocol (IP) and load balancer or other means that direct communication requests to designated endpoints in cloud computing platform 152. The components of cloud computing platform 152 may communicate with each other over a network (not shown), which may include, without limitation, one or more local area networks (LANs) and/or wide area networks (WANs).

### Example Computing Environment

Referring to FIG. 8, an example operating environment for implementing embodiments of the present invention is shown and designated generally as computing device 180. Essential elements of a computing device 180 or a computer or data processing system, etc. are one or more programmable processors 184 for performing actions in accordance with instructions and one or more memory devices 182 for storing instructions and data. Generally, a computer will also include, or be operatively coupled, (via bus, fabric, network, etc.,) to I/O components 190, e.g., display devices, network/communication subsystems, etc. and one or more mass storage devices 188 for storing data and instructions, etc., which are powered by a power supply 192.

Embodiments can be implemented in digital electronic circuitry, or in computer hardware, firmware, software, or in combinations thereof. Embodiments can be implemented in a computer program product tangibly stored in a machine-readable (e.g., non-transitory computer readable) hardware storage device for execution by a programmable processor; and method actions can be performed by a programmable processor executing a program of executable computer code (executable computer instructions) to perform functions of the invention by operating on input data and generating output. Embodiments can be implemented advantageously in one or more computer programs executable on a programmable system, such as a data processing system that includes at least one programmable processor coupled to receive data and executable computer code from, and to transmit data and executable computer code to, memory, and a data storage system, at least one input device, and at least one output device. Each computer program can be implemented in a high-level procedural or object-oriented programming language, or in assembly or machine language if desired; and in any case, the language can be a compiled or interpreted language.

Suitable processors include, by way of example, both general and special purpose microprocessors. Generally, a processor will receive executable computer code (executable computer instructions) and data from memory, e.g., a read-only memory and/or a random-access memory and/or other hardware storage devices. Generally, a computer will include one or more mass storage devices for storing data files; such devices include magnetic disks, such as internal hard disks and removable disks; magneto-optical disks; and optical disks. Hardware storage devices suitable for tangibly storing computer program executable computer code and data include all forms of volatile memory, e.g., semiconductor random access memory (RAM), all forms of non-volatile memory including, by way of example, semiconductor memory devices, such as EPROM, EEPROM, and flash memory devices; magnetic disks such as internal hard disks and removable disks; magneto-optical disks; and CD_ROM disks. Any of the foregoing can be supplemented by, or incorporated in, ASICs (application-specific integrated circuits).

A number of embodiments of the invention have been described. The embodiments can be put to various uses, such as educational, job performance enhancement, e.g., sales force and so forth. Nevertheless, it will be understood that various modifications may be made without departing from the scope of the invention.

What is claimed is:

1. A computer system comprises:
a recommender engine where a first plurality of customers prospects is exposed to a second plurality of potential actions, the recommender engine including executable computer instructions that configure the computer system to:
filter tuples of customers and actions according to one or more applied business rules;
generate features that identify a primary key that characterizes a specific feature to determine a minimum level of representation to eliminate redundancy, the feature generator executes a feature calculation to fit feature values per each primary key that are computed to subsequently reconstruct the feature per each primary key;
transform the features to return the feature values according to a number of primary keys that needs to be fetched;
compose, a feature matrix that includes a portion of the primary keys that needs to be fetched;
score the portion of the primary keys from feature matrix; and
issue recommendations for tuples of customers and actions according to the feature matrix.

2. The computer system of claim 1 wherein the recommender engine further comprises instructions to:
generate component matrices that represent factorized features.

3. The computer system of claim 2 wherein a matrix multiplication is applied to the factorized features represented through component matrices to provide a reconstructed matrix.

4. The computer system of claim 1 wherein instructions to generate features is separated from instructions to generate the feature matrix.

5. The computer system of claim 1 wherein the feature generation process provides a data structure where only unique primary keys and corresponding features values that are indexed by the primary keys are stored.

6. The computer system of claim 1 wherein the feature matrix is composed on demand.

7. The computer system of claim 6 wherein the feature matrix composed on demand comprises:
a feature class comprising:
a customer-level stored according to values of recency, frequency and, monetary;
an action-level stored according to values of discount and channel; and
a customer/action level stored according to a share of basket value and a propensity value.

8. The computer system of claim 7 wherein unique keys are processed in individual threads of execution by the computer system.

9. A computer implemented method where a first plurality of customers prospects is exposed to a second plurality of potential actions in a recommender engine, with the recommender engine including executable computer instructions that configure a computer system to:
filtering tuples of customers and actions according to one or more applied business rules;
generating features that identify a primary key that characterizes a specific feature to determine a minimum level of representation to eliminate redundancy, the feature generator executes a feature calculation to fit feature values per each primary key that are computed to subsequently reconstruct the feature per each primary key;
transforming the features to return the feature values according to a number of primary keys that needs to be fetched;
composing, a feature matrix that includes a portion of the primary keys that needs to be fetched;
scoring the portion of the primary keys from feature matrix; and
issuing recommendations for tuples of customers and actions according to the feature matrix.

10. The method of claim 9 wherein the recommender engine further comprises instructions for:
generating component matrices that represent factorized features.

11. The method of claim 10 wherein a matrix multiplication is applied to the factorized features represented through component matrices to provide a reconstructed matrix.

12. The method of claim 9 wherein generating features is separated from generating the feature matrix.

13. The method of claim 9 wherein the feature generation process provides a data structure where only unique primary keys and corresponding features values that are indexed by the primary keys are stored.

14. The method of claim 9 wherein the feature matrix is composed on demand.

15. The method of claim 14 wherein composing the feature matrix on demand comprises:
generating a feature class including a customer-level stored according to values of recency, frequency and, monetary, an action-level stored according to values of discount and channel, and a customer/action level stored according to a share of basket value and a propensity value.

16. The method of claim 15 further comprises instructions for:
processing unique keys in individual threads of execution by the computer system.

17. One or more non-transitory computer readable devices including executable computer instructions where a first plurality of customers prospects is exposed to a second plurality of potential actions in a recommender engine, with the recommender engine configuring a computer system to:
filter tuples of customers and actions according to one or more applied business rules;
generate features that identify a primary key that characterizes a specific feature to determine a minimum level of representation to eliminate redundancy, the feature generator executes a feature calculation to fit feature values per each primary key that are computed to subsequently reconstruct the feature per each primary key;
transform the features to return the feature values according to a number of primary keys that needs to be fetched;
compose, a feature matrix that includes a portion of the primary keys that needs to be fetched;
score the portion of the primary keys from feature matrix; and
issue recommendations for tuples of customers and actions according to the feature matrix.

18. The one or more non-transitory computer readable devices of claim 17 further comprises instructions to:
generate component matrices that represent factorized features.

19. The one or more non-transitory computer readable devices of claim 18 wherein a matrix multiplication is applied to the factorized features represented through component matrices to provide a reconstructed matrix.

20. The one or more non-transitory computer readable devices of claim 17 wherein instructions to generate features is separated from instructions to generate the feature matrix.

21. The one or more non-transitory computer readable devices of claim 17 wherein the feature generation process provides a data structure where only unique primary keys and corresponding features values that are indexed by the primary keys are stored.

22. The one or more non-transitory computer readable devices of claim 17 wherein the feature matrix is composed on demand.

23. The one or more non-transitory computer readable devices of claim 22 wherein the feature matrix is composed on demand and includes:
a feature class including:
a customer-level stored according to values of recency, frequency and, monetary;
an action-level stored according to values of discount and channel; and
a customer/action level stored according to a share of basket value and a propensity value.

24. The one or more non-transitory computer readable devices of claim 23 wherein unique keys are processed in individual threads of execution by the computer system.
